(19) United States
(12) Patent Application Publication
(10) Pub. No.: US 2016/0360605 A1
(43) Pub. Date: Dec. 8, 2016

(54) CONTROLLER FOR AND CONTROLLING NEUTRON ORBITAL ANGULAR MOMENTUM

(71) Applicants: DMITRY A. PUSHIN, BOSTON, MA (US); ROMAN A. BARANKOV, BROOKLINE, MA (US); NATIONAL INSTITUTE OF STANDARDS AND TECHNOLOGY, GAITHERSBURG, MD (US)

(72) Inventors: CHARLES W. CLARK, WHEATON, MD (US); MICHAEL G. HUBER, POOLESVILLE, MD (US); DMITRY A. PUSHIN, BOSTON, MA (US); ROMAN A. BARANKOV, BROOKLINE, MA (US)

(21) Appl. No.: 15/172,547

(22) Filed: Jun. 3, 2016

Related U.S. Application Data
(60) Provisional application No. 62/171,017, filed on Jun. 4, 2015.

(51) Int. Cl. H05H 15/00; H05H 3/06

(52) U.S. Cl. CPC H05H 15/00; H05H 3/06

(57) ABSTRACT

An orbital angular momentum (OAM) controller controls OAM of a plurality of neutrons and includes: a substrate; a first surface of the substrate; and a second surface of the substrate disposed opposingly across the substrate from the first surface and including a contoured shape. A process for controlling OAM of neutrons includes: subjecting an OAM controller to a plurality of neutrons; receiving the neutrons at a first surface of the OAM controller; transmitting the neutrons through the OAM controller; and providing a phase shift θ to a wavefunction of neutrons transmitted through the OAM controller according to θ∝T₁+T₂(φ/2π), wherein T₁ is a first thickness of a substrate of the OAM controller, T2 is a second thickness of the substrate, and φ is an azimuthal angle of the substrate.

### CROSS REFERENCE TO RELATED APPLICATIONS

This application claims the benefit of U.S. Provisional Patent Application Ser. No. 62/171,017, filed Jun. 4, 2015, the disclosure of which is incorporated herein by reference in its entirety.

### STATEMENT REGARDING FEDERALLY SPONSORED RESEARCH

This invention was made with United States Government support from the National Institute of Standards and Technology. The Government has certain rights in the invention.

### BRIEF DESCRIPTION

Disclosed is an orbital angular momentum (OAM) controller to control OAM of a plurality of neutrons, the OAM controller comprising: a substrate; a first surface of the substrate; and a second surface of the substrate disposed opposingly across the substrate from the first surface and comprising a contoured shape that, in combination with the first surface, controls the OAM of the neutrons.

Further disclosed is an orbital angular momentum (OAM) controller to control OAM of a plurality of neutrons, the OAM controller comprising: a substrate; a first surface of the substrate; and a second surface of the substrate disposed opposingly across the substrate from the first surface and comprising a contoured shape that, in combination with the second surface, controls the OAM of the neutrons, the OAM controller: being a spiral phase plate that comprises a variation in a thickness of the substrate as a function of an azimuthal angle φ of the substrate, and providing a phase shift θ to a wavefunction of neutrons transmitted through the OAM controller according to

$$θ ∝ {T}_{1} + {T}_{2} \frac{φ}{2 π} ,$$

wherein T1 is a first thickness of the substrate, T2 is a second thickness of the substrate, and φ is the azimuthal angle of the substrate.

Also disclosed is a neutron holograph comprising: an interferometer comprising: a reference arm to propagate a reference beam; and an object arm to propagate an object beam; an orbital angular momentum (OAM) controller to control OAM of a plurality of neutrons, the OAM controller disposed in the object arm and comprising: a substrate; a first surface of the substrate; and a second surface of the substrate disposed opposingly across the substrate from the first surface and comprising a contoured shape that, in combination with the second surface, controls the OAM of the neutrons; and a prism disposed in the reference arm.

Additionally disclosed is a process for controlling orbital angular momentum (OAM) of a plurality of neutrons, the process comprising: subjecting an OAM controller to a plurality of neutrons; receiving, by the OAM controller, the neutrons at a first surface of the OAM controller; transmitting the neutrons through the OAM controller from the first surface to a second surface of the OAM controller, the second surface being disposed opposingly across a substrate of the OAM controller from the first surface and comprising a contoured shape; and providing, by the OAM controller, a phase shift θ to a wavefunction of neutrons transmitted through the OAM controller to control the OAM of the neutrons according to

$$θ ∝ {T}_{1} + {T}_{2} \frac{φ}{2 π} ,$$

wherein T1 is a first thickness of the substrate, T2 is a second thickness of the substrate, and φ is the azimuthal angle of the substrate.

### BRIEF DESCRIPTION OF THE DRAWINGS

The following descriptions should not be considered limiting in any way. With reference to the accompanying drawings, like elements are numbered alike.

FIG. 1 shows a perpsective view of an orbital angular momentum (OAM) controller that includes a second surface with a contour that is a counterclockwise spiral;

FIG. 2 shows a top view of the OAM controller shown in FIG. 1;

FIG. 3 shows a bottom view of the OAM controller shown in FIG. 1;

FIG. 4 shows a cross-sectional view along line A-A of the OAM controller shown in FIG. 2;

FIG. 5 shows a graph of thickness versus an azimuthal angle of the OAM controller shown in FIG. 1;

FIG. 6 shows a solid model of an OAM controller;

FIG. 7 shows neutrons before and after transmission by an OAM controller that includes a second surface with a contour that is a counterclockwise spiral;

FIG. 8 shows neutrons before and after transmission by an OAM controller that includes a second surface with a contour that is a clockwise spiral;

FIG. 9 shows a perpsective view of an orbital angular momentum (OAM) controller that includes a second surface with a contour that is a clockwise spiral;

FIG. 10 shows a top view of the OAM controller shown in FIG. 9;

FIG. 11 shows a bottom view of the OAM controller shown in FIG. 9;

FIG. 12 shows a cross-sectional view along line B-B of the OAM controller shown in FIG. 10;

FIG. 13 shows a graph of thickness versus an azimuthal angle of the OAM controller shown in FIG. 9;

FIG. 14 shows a perpsective view of an OAM controller that includes a second surface with a contour that has two clockwise spirals;

FIG. 15 shows a top view of the OAM controller shown in FIG. 14;

FIG. 16 shows a graph of thickness versus an azimuthal angle of the OAM controller shown in FIG. 14;

FIG. 17 shows a perpsective view of an OAM controller that includes a second surface with a contour that has three clockwise spirals;

FIG. 18 shows a top view of the OAM controller shown in FIG. 17;

FIG. 19 shows a perpsective view of an OAM controller that includes a second surface with a contour that has four clockwise spirals;

FIG. 20 shows a top view of the OAM controller shown in FIG. 19;

FIG. 21 shows a photograph of an OAM controller;

FIG. 22 shows a photograph of an OAM controller;

FIG. 23 shows a neutron holograph;

FIG. 24 shows a neutron interferometer;

FIG. 25 shows OAM interferograms;

FIG. 26 shows OAM interferograms;

FIG. 27 shows OAM interferograms;

FIG. 28 shows raw data for images according to Example 1;

FIG. 29 shows images obtained during data processing of raw data according to Example 1;

FIG. 30 shows images obtained during modelling noise in image data according to Example 1;

FIG. 31 shows intensity profiles according to Example 2;

FIG. 32 shows intensity profiles according to Example 2; and

FIG. 33 shows images for intensity and phase reconstruction according to Example 2.

### DETAILED DESCRIPTION

A detailed description of one or more embodiments is presented herein by way of exemplification and not limitation.

It has been discovered that an orbital angular momentum (OAM) controller herein provides a helical wavefront to neutrons to control OAM states of the neutrons transmitted through the OAM controller.

An OAM state of a neutron can be described with a paraxial approximation from wave mechanics. Here, a wavefunction of a freely propagating neutron is written as

Φ(r)=e^{ik}^{_{z}}^{z}Ψ(r),

wherein k_{z}≈\sqrt{2mE}/ is a wavevector of the neutron with mass m and energy E propagating forward along a z axis; r=(x, y, z) is a position vector; and envelope function Ψ(r) satisfies a two-dimensional Helmholtz equation as provided in formula 1.

$$( \frac{{\partial }^{2}}{\partial {x}^{2}} + \frac{{\partial }^{2}}{\partial {y}^{2}} ) Ψ + 2 {ik}_{z} \frac{\partial Ψ}{\partial z} = 0. \qquad ( 1 )$$

OAM states include a complete set of solutions to formula 1 in cylindrical coordinates (ρ, φ, z), wherein x=ρ cos(φ), and y=ρ sin(φ). Eigenfunctions for the neutron are provided by Ψ/(ρ, φ, z)=u/(ρ, z)exp(i/φ), wherein the function u/(ρ, z) describes a transverse radial structure of a wavefront of the eigenfunction as a function of a propagation coordinate z. The function exp(i/φ) is an eigenfunction of OAM operator \hat{l}_{z}=−i∂/∂φ with eigenvalue l, wherein l=0, ±1, ±2, . . . is an integer. For l=0, the envelope function reduces to a diffracting beam having a Gaussian profile in a transverse direction at any axial position z.

For an arbitrary value of L, the phase factor e^{iLφ} generated by the OAM controller herein describes a superposition of OAM states of neutrons transmitted through the OAM controller as provided in formula 2.

$${e}^{i Lϕ} = {\sum }_{l = 0 , \pm 1 , ⋯} {β}_{l} {e}^{i lϕ} \qquad ( 2 )$$

wherein amplitudes βₗ are given by overlaps of a phase factor and the OAM eigenfunctions provided in formula 3.

βₗ=e^{i(L-l)π}sinc(L−l) (3)

wherein sinc(x)=sin(πx)/(πx). For a plurality of neutrons configured in a neutron beam with an angular momentum of zero that is transmitted through the OAM controller, the probability distribution of resulting OAM states of the transmitted neutrons is wₗ=|βₗ|². It is contemplated that, for a thickness of the OAM controller that provides a non-integer value of L, e.g., L=7.5, a superposition of different OAM states of the neutrons is produced by the OAM controller, e.g., with a dominant contribution from l=7 and l=8. Given an uncertainty of L, even for the values of L=n+δL close to integers n=0, ±1, . . . , a resulting OAM state is a combination of OAM states of the neutrons that make up the neutron beam.

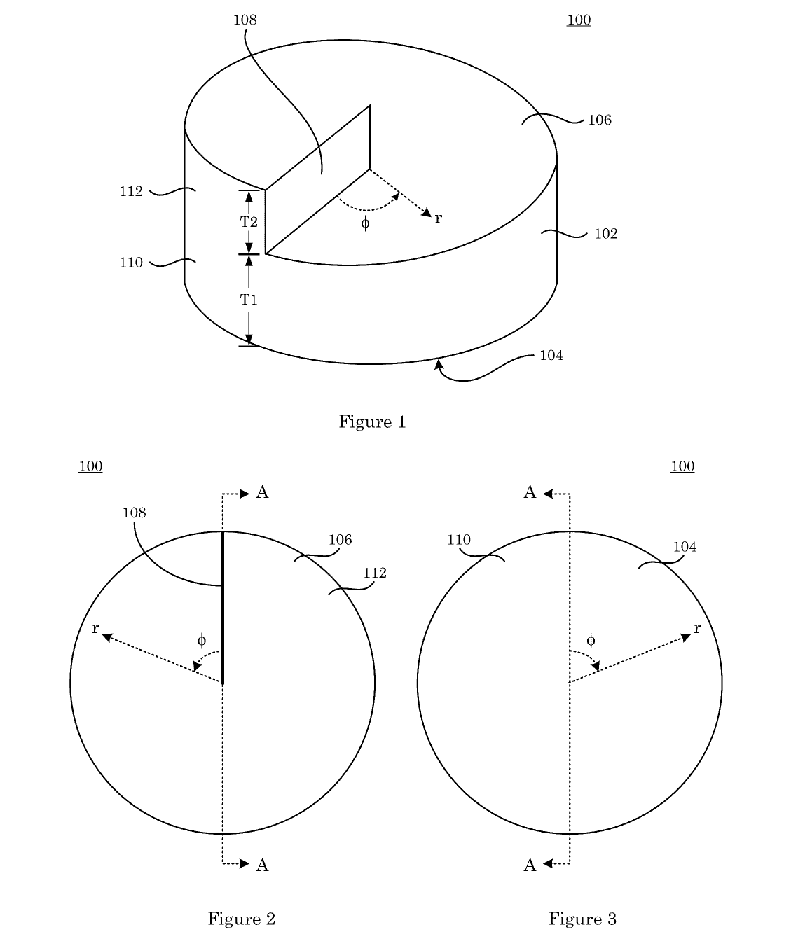

In an embodiment, with reference to FIG. 1 (perspective view), FIG. 2 (top view showing second surface 106), and FIG. 3 (bottom view showing first surface 104), OAM controller 100 is provided to control OAM of a plurality of neutrons and includes: substrate 102; first surface 104 of substrate 102; and second surface 106 of substrate 102 disposed opposingly across substrate 102 from first surface 106 and including a contoured shape that, in combination with first surface 104, controls the OAM of the neutrons. Here, substrate 102 is divided into base 110 to provide first surface 104 and contoured member 112 to provide second surface 106. In addition, second surface 106 terminates at step edge 108. Base 110 has first thickness T1, and contoured member 112 has second thickness T2. Radial position r of substrate 102 and azimuthal angle φ of substrate 102 are also shown in FIG. 1, FIG. 2, and FIG. 3. Here, second thickness T2 of substrate 102, namely contoured member 112, varies as a function of azimuthal angle φ although in some embodiments, second thickness T2 can be constant as a function of azimuthal angle φ. Also here, second thickness T2 is constant as a function of radial position r, but it is contemplated that second thickness T2 can vary as a function of radial position r in some embodiments. Additionally here, first thickness T1 is constant over azimuthal angle φ and radial position r. In some embodiments, first thickness T1 can vary over azimuthal angle φ, radial position r, or a combination thereof.

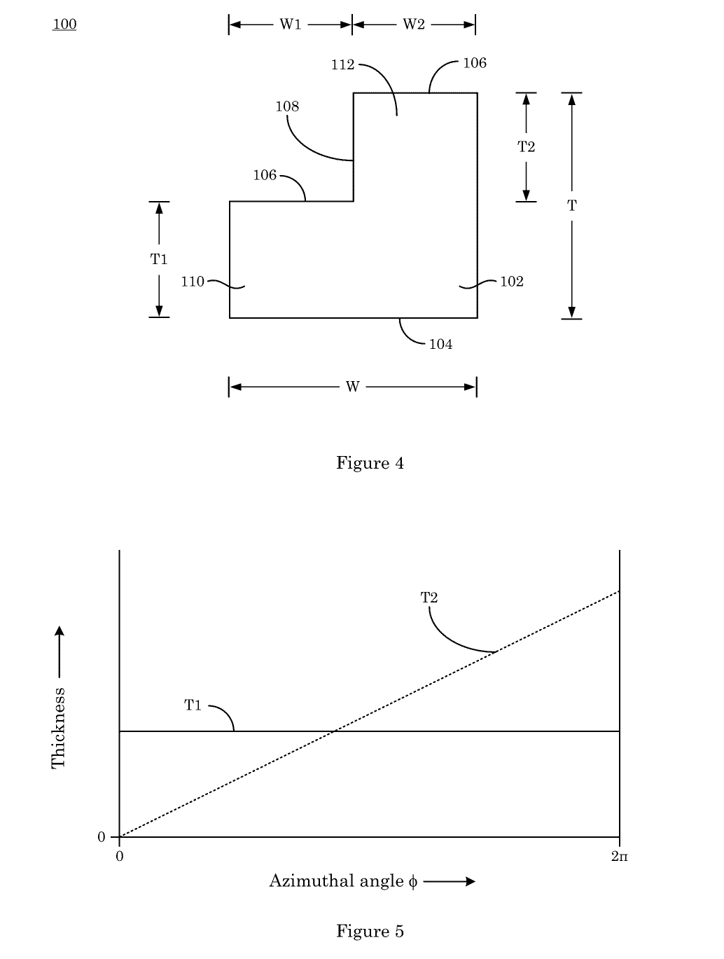

Radial position r increases from a central position of substrate 102 and has a largest value at a periphery of substrate 102. Azimuthal angle φ has a value of zero at step edge 108 and increases to 2π in a counterclockwise direction as viewed from the top view of OAM controller 100 shown in FIG. 2. FIG. 4 shows a cross-sectional view of OAM controller 100 along line A-A shown in FIG. 2 and FIG. 3 in which step edge 108 forms a boundary of contoured member 112 at φ=2π. Here, substrate 102 at base 110 and first surface 104 has a width W (e.g., diameter). Second surface 106 includes a plurality of widths, e.g., first width W1 (proximate to base 110) and second width W2 (distal to base 110), wherein W=W1+W2. In some embodiments, first width W1 is identically or substantially similar to second W2. In a certain embodiment, first width W1 is different from second width W2. According to an embodiment, first width W1 is greater than second width W2. In a particular embodiment, first width W1 is less than second width W2. In an embodiment, OAM controller 100 is the spiral phase plate, wherein first width W1 is the same as second width W2.

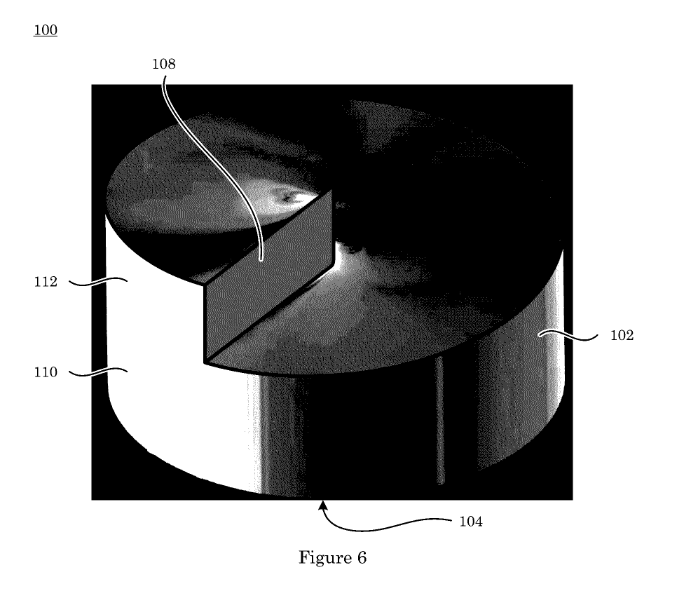

In an embodiment, second thickness T2 varies uniformly as a function of azimuthal angle φ, e.g., linearly with azimuthal angle φ as shown in FIG. 5 while first thickness T1 is constant in azimuthal angle φ. With this configuration of first thickness T1 and second thickness T2, OAM controller is a spiral phase plate, wherein the contoured shape of second surface 106 is a spiral, and first surface 104 is a planar surface. A solid model of the spiral phase plate format of OAM controller 100 is shown in FIG. 6.

A shape of substrate 102 with respect to a transverse cross-section in a plane spanned by azimuthal angle φ through base 110 can be circular, e.g., as indicated in the bottom view of OAM controller 100 shown in FIG. 3. Without limitation, the shape of substrate 102 can be polygonal (e.g., triangular, square, rectangular, hexagonal, and the like), ellipsoidal, irregular, star-shaped, and the like, so long as OAM controller 100 controls OAM of neutrons transmitted through OAM controller 100. Further, although first surface 104 is shown as being planar, first surface 104 can have a shape that in combination with second surface 106 provides OAM controller 100 with control of OAM for neutrons transmitted through OAM controller 100. Such shapes of first surface 104 can include convex, concave, dimpled, corrugated, spiral, and the like, or a combination thereof. Similarly, although second surface 106 is shown as being spiral for its contoured shape, second surface 106 can have a shape that in combination with first surface 104 provides OAM controller 100 with control of OAM for neutrons transmitted through OAM controller 100. Such shapes of second surface 106 include convex, concave, dimpled, corrugated, planar, spiral, and the like, or a combination thereof.

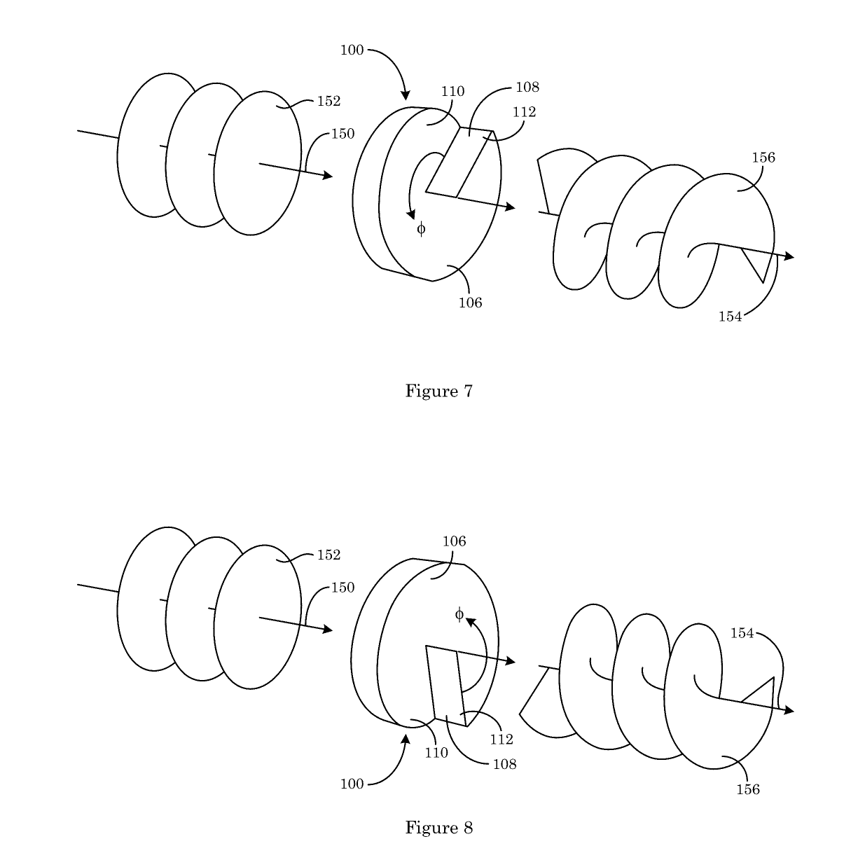

With reference to FIG. 7, OAM controller 100 receives a plurality of neutrons 150 having a distribution of first OAM states described by first wavefunction 152 (shown here as a planar wavefunction). OAM controller 100 interacts with neutrons 150 and transmits them as neutrons 154 in which OAM controller 100 changes the first OAM states to second OAM states of neutrons 154 described by second wavefunction 156 (shown here as a helical wavefunction). That is, neutrons 150 in first OAM states with first wavefunction 152 are incident at first surface 104 and transmitted through OAM controller 100. As a result, OAM controller 100 transmits from second surface 106 neutrons 156 having second wavefunction 156, wherein OAM controller 100 changed the first OAM states to the second OAM states. Accordingly, OAM controller 100 imparts a change in OAM from first neutrons 150 to second neutrons 156. Moreover, second thickness T2 increases counterclockwise corresponding to an increase of azimuthal angle φ such that neutrons 154 have a clockwise helical OAM with respect to direction of propagation of neutrons 154.

The variation of thickness T of OAM controller 100 can be selected to provide a selectively tailored helix as OAM control for the OAM of neutrons 154 transmitted by OAM controller 100. In an embodiment, with reference to FIG. 8, OAM controller 100 receives a plurality of neutrons 150 with first OAM states described by first wavefunction 152 (shown here as the planar wavefunction). OAM controller 100 interacts with neutrons 150 and transmits them as neutrons 154 in which OAM controller 100 changes the first OAM states of neutrons 150 to second OAM states of neutrons 154 described by second wavefunction 156 (shown here as the helical wavefunction). Here, OAM controller 100 imparts a change in OAM from first neutrons 150 to second neutrons 156, wherein second thickness T2 increases clockwise corresponding to a decrease of azimuthal angle φ such that neutrons 154 have a counterclockwise helical OAM with respect to direction of propagation of neutrons 154.

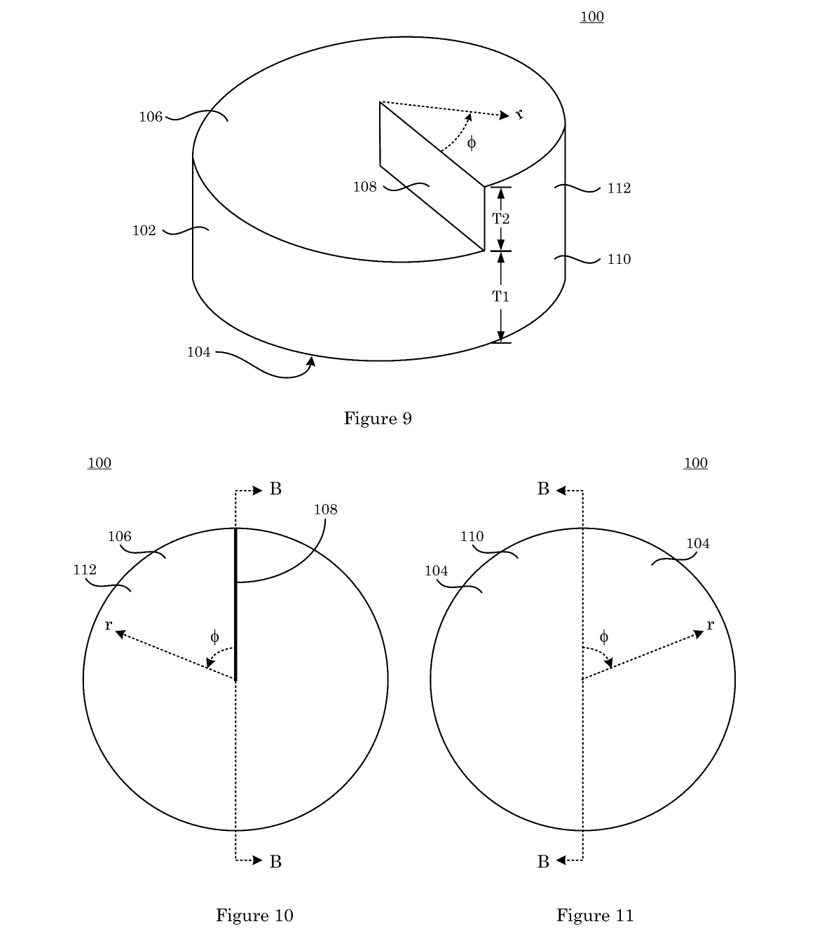

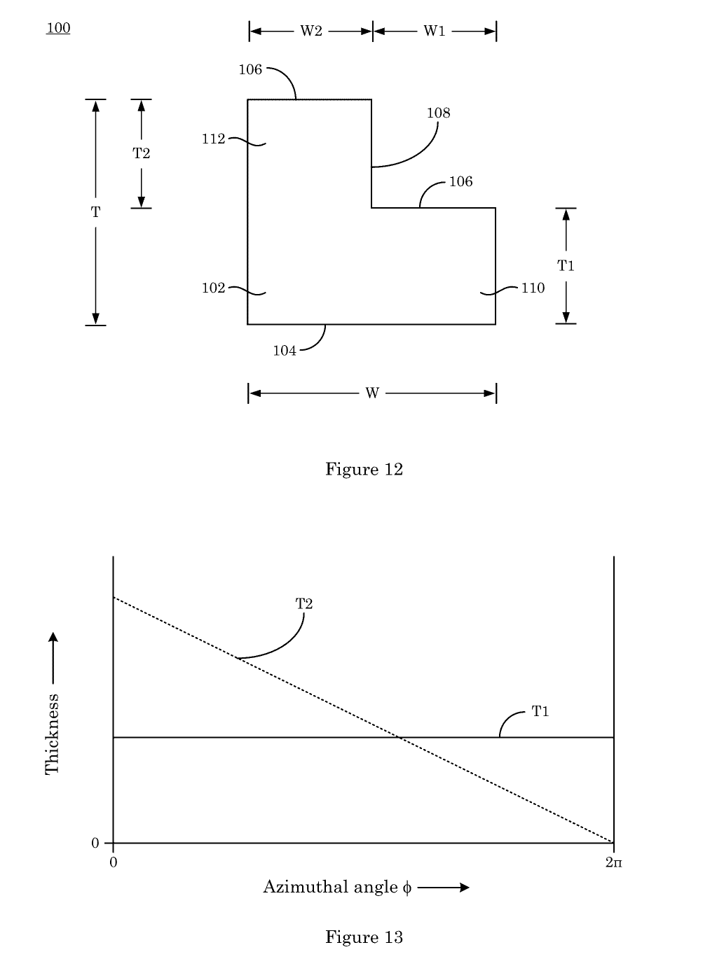

In an embodiment, as shown in with reference to FIG. 9 (perspective view), FIG. 10 (top view showing second surface 106), and FIG. 11 (bottom view showing first surface 104), OAM controller 100 controls OAM of a plurality of neutrons and includes: substrate 102; first surface 104 of substrate 102; and second surface 106 of substrate 102 disposed opposingly across substrate 102 from first surface 106 and including a contoured shape that, in combination with first surface 104, controls the OAM of the neutrons. Here, second thickness T2 of substrate 102, namely contoured member 112, decreases as a function of azimuthal angle φ and is constant as a function of radial position r, and first thickness T1 being constant over azimuthal angle φ and radial position r. That is, the spiral shape of second surface 106 is a clockwise spiral with respect to increase in azimuthal angle φ. Moreover, second thickness T2 varies uniformly as a function of azimuthal angle φ, e.g., linearly with azimuthal angle φ as shown in FIG. 13 FIG. 5 while first thickness T1 is constant in azimuthal angle φ. With this configuration of first thickness T1 and second thickness T2, OAM controller is a spiral phase plate, wherein the contoured shape of second surface 106 is a spiral, and first surface 104 is a planar surface. A cross-section along line B-B (see FIG. 10 and FIG. 11) is shown in FIG. 12. With this geometrical shape and increase in thickness T over azimuthal angle φ, OAM controller 100 controls OAM of neutrons from a first OAM state to a second OAM state.

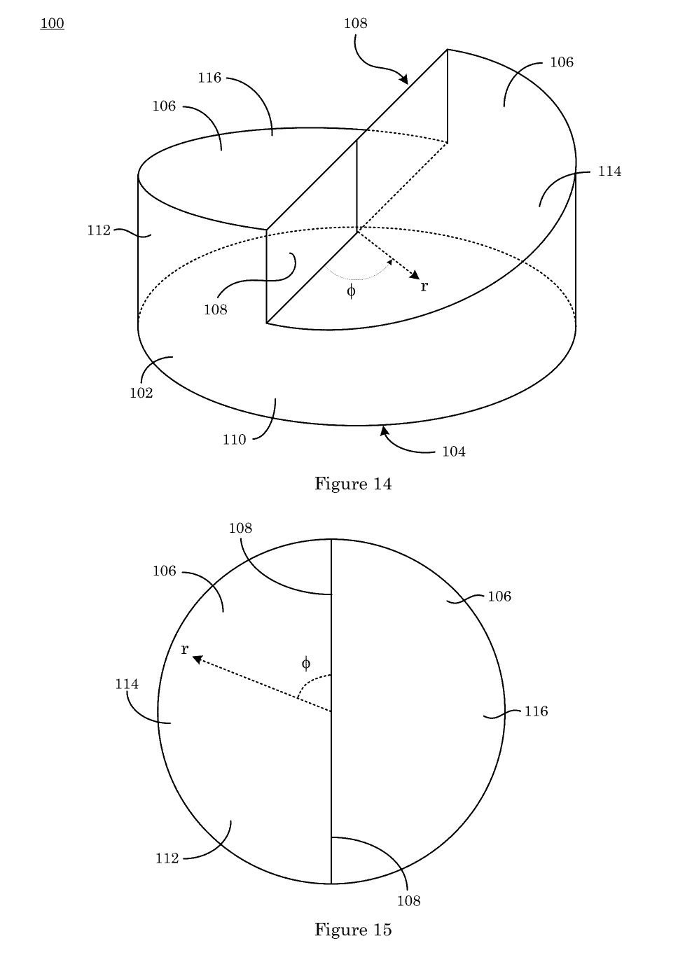

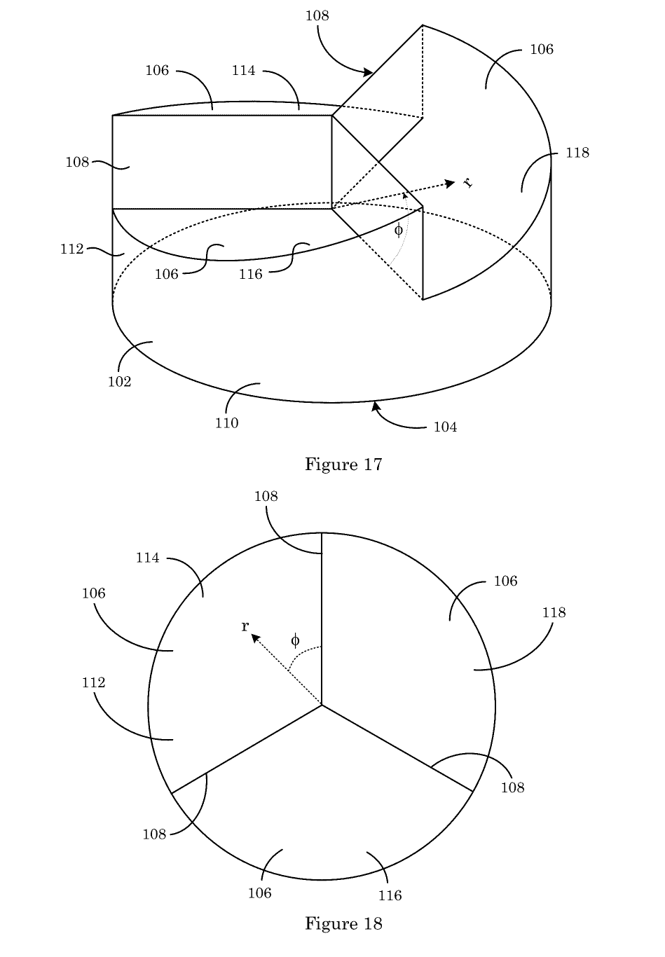

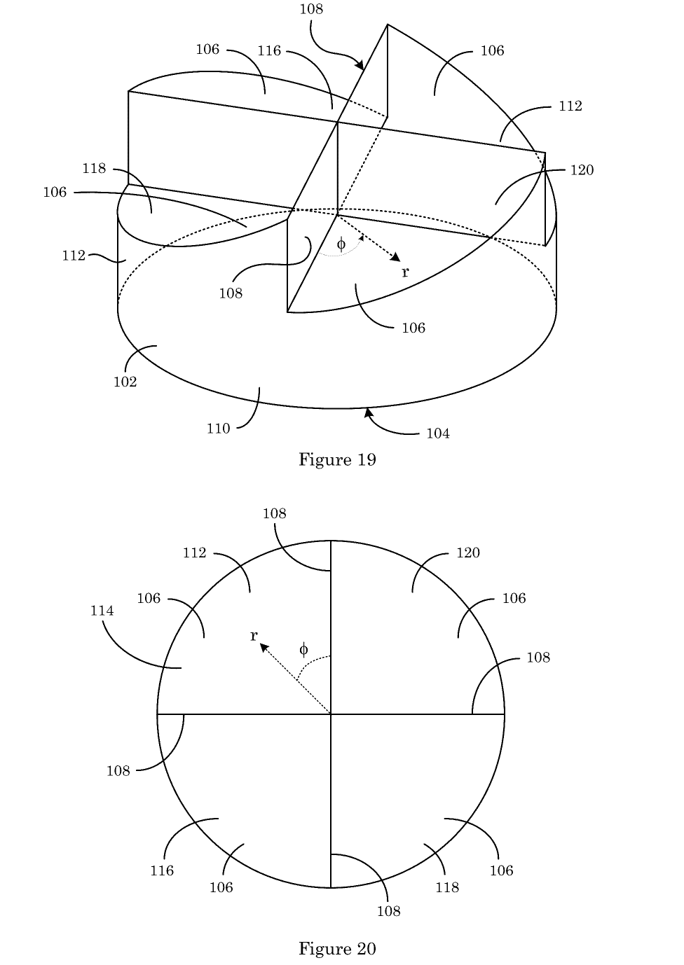

OAM controllers 100 shown in FIG. 1 and FIG. 9 include a single spiral as the contoured shape of second surface 106. In an embodiment, OAM controller 100 includes a plurality of spirals for the contoured shape of second surface 106, e.g., as shown in FIG. 14, FIG. 17, and FIG. 19.

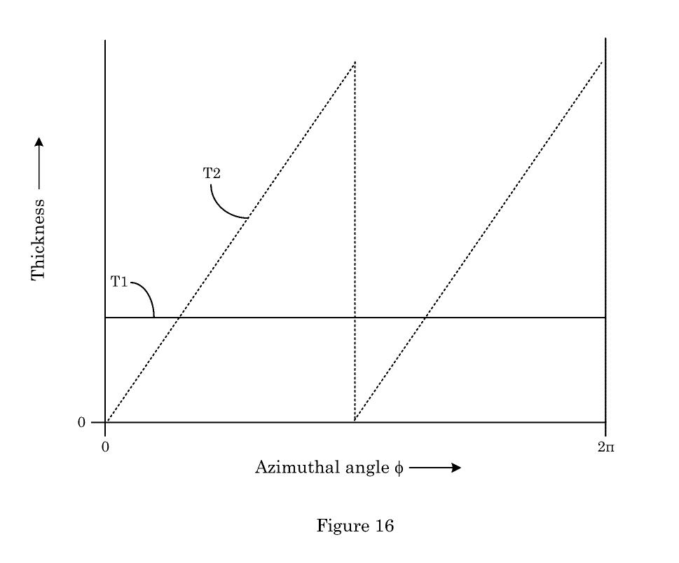

In an embodiment, with reference to FIG. 14, OAM controller 100 includes two spirals as first spiral 114 and second spiral 116. A top view of OAM controller 100 from FIG. 14 is shown in FIG. 15. FIG. 16 shows a graph of first thickness T1 and second thickness T2 as a function of azimuthal angle φ. Here, second thickness T2 increases along 0<φ<π; is zero at φ=0, π, and 2π; and increases from π<φ<2π. Although the thickness of second thickness T2 repeats with a period of it radians with respect to azimuthal angle φ in FIG. 16, second thickness T2 can have different amplitudes for different periods with respect to azimuthal angle φ, including some periods in which second thickness increases and some periods in which second thickness T2 decreases.

In an embodiment, with reference to FIG. 17, OAM controller 100 includes three spirals as first spiral 114, second spiral 116, and third spiral 118. A top view of OAM controller 100 from FIG. 17 is shown in FIG. 18. According to an embodiment, with reference to FIG. 19, OAM controller 100 includes four spirals as first spiral 114, second spiral 116, third spiral 118, and fourth spiral 120. A top view of OAM controller 100 from FIG. 19 is shown in FIG. 20.

Substrate 102 is a material effective to transmit and control OAM of neutrons. Substrate 102 can include a metal, polymer, glass, ceramic, and the like. In an embodiment, substrate 102 is opaque to light (e.g., visible light and ultraviolet light), opaque to electrons, and transmits neutrons. OAM controller 100 also can be opaque to X-rays. Substrate 102 can include a neutron transparent metal, e.g., aluminum, titanium, bismuth, lead, or a combination thereof. An additive can be included with the metal to produce a neutron index of refraction of OAM controller 100 or to improve machinability, ease of fabrication of OAM controller 100, and the like. Exemplary additives include a metal alloy of the neutron transparent metals. In an embodiment, the substrate includes aluminum, e.g., 6061 aluminum. It is contemplated that substrate 102 is not activated in response to transmitting the neutrons therethrough.

As used herein, “opaque” refers to a transmission of substrate 102 with regard to a particular wavelength of radiation or a particular type of particle in which substrate 102 is not transparent and is not translucent to the wavelength or particle. As used herein, “transparent” refers to transmitting all photons at the wavelength or all such particles. As used herein, “translucent” refers to transmitting some photons at the wavelength or some of the particles.

OAM is associated with rotation of the neutron about a fixed axis. Axial particle currents are encoded in the spiral (also referred herein as helical) phase profile of the wavefunction of the neutron. The component of OAM parallel to the axis of rotation is quantized in an integer multiple of reduced Planck constant . Quantization of OAM is a consequence of the wavefunction having a single value, wherein the wavefunction is a periodic function of rotation angle, with a period of 2π radians. When interactions of the neutron with an environment are symmetric with respect to such rotations, OAM is conserved. OAM controller 100 changes the OAM of the neutron by producing a twist on the wavefunction. Here, OAM controller 100 can be a macroscopic member such as a phase plate having second surface 106 that can have the contoured shape such as a spiral staircase. The contoured shape of second surface 106 in combination with first surface 104 can be selected to match a phase profile of an OAM state. Neutrons transmitted through OAM controller 100 (e.g., the spiral phase plate (SPP)) obtain axial rotation around the direction of propagation of the neutrons, which is a quantization axis of the neutrons.

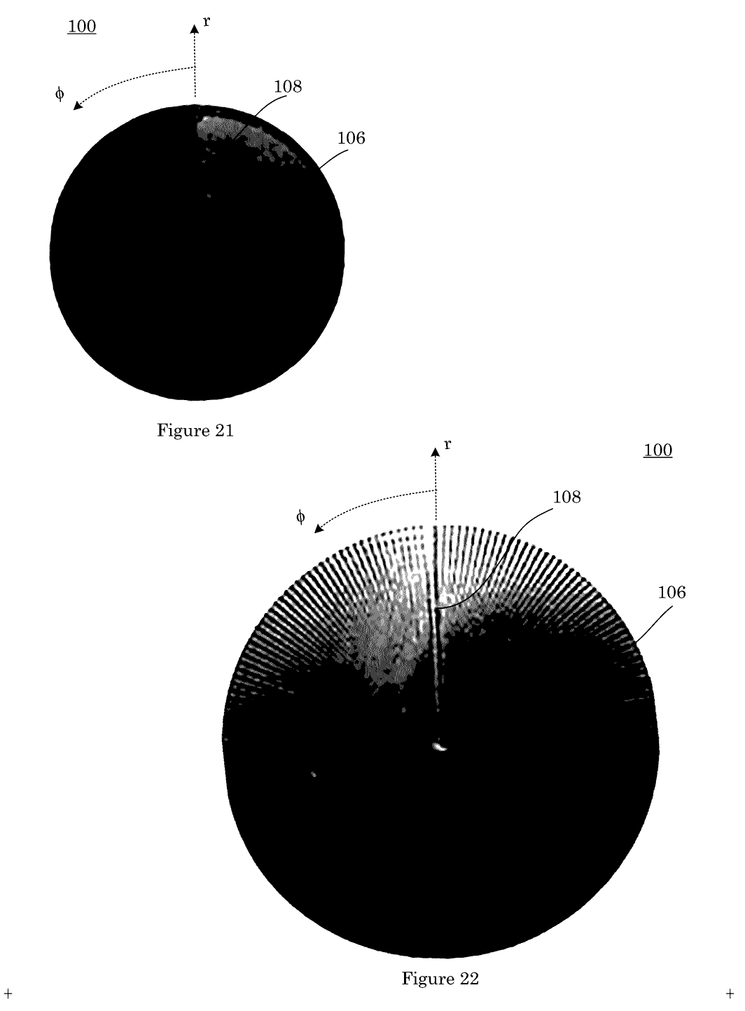

OAM controller 100 changes an orbital angular momentum composition of wavefunction Ψ. Here, as OAM controller 100 transmits neutrons through substrate 102, wherein wavefunction Ψ is changed by a transmission amplitude such that Ψ→exp(iθ)Ψ, wherein θ is a phase function of OAM controller 100. FIG. 1 shows a perspective view of OAM controller 100, and FIG. 21 and FIG. 22 show a photograph of OAM controllers 100 that respectively have a diameter of substrate of 10 mm and 15 mm. With reference to FIG. 1, thickness T OAM controller 100 varies with azimuthal angle φ as provided by formula 4

$$T = T 1 + S ( \frac{φ}{2 π} ) , \qquad ( 4 )$$

wherein T1 is thickness of base 110 as described above, and S is a thickness of second thickness T2 at step edge 108, i.e., a step height of the spiral of second surface 106.

Interaction of neutrons with a material is modelled using an optical potential in which the phase shift with respect to vacuum of a neutron passing through OAM controller 100 (e.g., the spiral phase plate) is provided by formula 5

$$θ = - {Nb}_{c} λ T = - {Nb}_{c} λ ( T 1 + S ( \frac{φ}{2 π} ) ) , \qquad ( 5 )$$

wherein N is an atom density of substrate 102; b_{c} is a coherent scattering length of material of OAM controller 102, and A is a wavelength of the neutron, e.g., =0.271 nm. In an embodiment, OAM controller 100 provides a phase shift of pπ, wherein p is an integer or half-integer, e.g., ½, 1, 3/2, 2, and the like. According to an embodiment, OAM controller 100 includes a shift of 2π. Here, substrate 102 can include aluminum such that step height S is 112 μm, which is greater than the neutron wavelength. An index of refraction n for neutrons at this wavelength in aluminum is very close to unity, wherein 1−n=Nb_{c}λ²/(2π)≈2.43×10⁻⁶. OAM controllers 100 shown in FIG. 21 and have S=224 μm.

OAM controller 100 provides neutrons 154 (see e.g., FIG. 7 or FIG. 8) transmitted by OAM controller 100 an azimuthal phase twist of 2πL, wherein effective angular momentum L=Nb_{c}λS/(2π) is a function of spiral step height S. OAM components of neutrons 150 (e.g., an incoherent neutron beam) entering OAM controller 100 obtains an additional phase twisting proportional to L. An average angular momentum of the neutron in units of is (L)=L₀+L, where L₀ is an initial average OAM of the neutrons, which varies for different neutrons of the incoherent beam. It is contemplated that, when angular momentum with which a neutron enters OAM controller 100 is uncertain, an outgoing state of the neutron also is uncertain.

In an embodiment, OAM controller 100 imparts a phase shift to a wavefunction of the neutrons that are transmitted through OAM controller 100. The phase shift can be proportional to a local thickness, e.g., a sum of first thickness T1 and second thickness T2 at azimuthal angle φ, of substrate 102. Moreover, for neutrons transmitted through OAM controller 100, the wavefunction acquires an azimuthal phase distribution provided by e^{iLφ}, wherein L is an integer, and i is equal to a square root of −1. Further, an azimuthal distribution of thickness T of substrate 102 can be selected for a specific value of L such that neutrons that transmitted through OAM controller 100 include a value of OAM that is equal to L. According to an embodiment, the wavefunction of the neutrons prior to transmission through OAM controller 100 include a planar wavefunction.

In an embodiment, OAM controller 100 control OAM of the plurality of neutrons and includes: substrate 102; first surface 104 of substrate 102; and second surface 106 of substrate 102 disposed opposingly across substrate 102 from first surface 104 and including the contoured shape that, in combination with first surface 104, controls the OAM of the neutrons. Here, OAM controller 100 is the spiral phase plate that includes the variation in thickness T of substrate 102 as a function of azimuthal angle φ of substrate 102. OAM controller 100 provides phase shift θ to the wavefunction of neutrons transmitted through OAM controller 100 according to θ∝T₁+Sφ/2π, and substrate 102 is opaque to light, opaque to electrons, opaque to X-rays, and transmits neutrons.

OAM controller 100 can be made in various ways. In an embodiment, a process for making OAM controller 100 includes: providing a material for substrate 102; and removing some of the material to form the contoured surface of second surface 106. First surface 104 can be formed on machining a portion of substrate 102. Removing some of the material to form the Concorde service second surface 106 can include cutting, sanding, and the like. According to an embodiment, OAM controller 100 is machined from a dowel of an aluminum alloy, e.g., Al 6061 alloy, by a computer numerical control (CNC) milling machine to form substrate 102. Second surface 106 and first surface 104 can be formed from substrate 102 by rotating and cutting substrate 102 while moving an end mill outward from substrate 102 to form the contoured shape of second surface 106. Alternatively, second surface 106 can be formed from substrate 102 by milling the contoured shaped in substrate 102 having a helical staircase pattern with a selected number of treads to form second surface 106. First surface 104 or second surface 106 can be subjected to surface finishing such as polishing, roughening, chemical treatment (e.g., deposition or etching), mechanical treatment (e.g., hardening), and the like.

According to an embodiment, OAM controller 100 is made by molding a metal into substrate 102 interposed between first surface 104 and the second surface 106, wherein the mold provides the card toward shape of second surface 106.

In an embodiment, substrate 102 is a laminate structure, wherein contoured member 112 includes second surface 106 and is disposed on base 110 having first surface 104. Here, contoured member 112 can be attached to base 110 mechanically (e.g., with a fastener (e.g., a screw that can include a same or different material as base 110 or contoured member 112) that can be inside or outside of region of substrate 102 subjected to neutrons), chemically (e.g., with a neutron transparent adhesive, alloying, melting, and the like), and the like. Here, OAM controller 102 can be made by disposing contoured member 112 on base 110 and fastening contoured member 112 to base 110. It is contemplated that base 110 is the same material as contoured member 112. In some embodiments, base 110 is a different material than contoured member 112.

According to an embodiment, OAM controller 100 is made by printing substrate 102 can include first surface 104 and second surface 106. Printing can be accomplished, e.g., by a three-dimensional printer that dispenses a selected material for substrate 102 such as a metal, e.g., a low-temperature alloy.

According to an embodiment, OAM controller 100 is made by nanolithographic depositing substrate 102 to include first surface 104 and second surface 106. Lithography can be accomplished, e.g., by a focused ion or electron beam to disposed or removes a material for substrate 102, e.g., a metal such as a low-temperature alloy.

A size of OAM controller 100 is selected to control OAM of neutrons transmitted through substrate 102. Thickness T can be any thickness to provide OAM control of the neutrons, e.g., from 10 nanometers (nm) to 10 centimeters (cm), specifically from 100 μm to 50 mm

A diameter of substrate 102 can be can be any size so that OAM controller 100 controls OAM of the neutrons, e.g., from 1 μm to 10 cm so long.

OAM controller 100 can transmit neutrons having a wavelength from 1 Angstrom (Å) to 2000 Å, specifically from 1 Å to 100 Å, and more specifically from 2 Å to 5 Å.

OAM controller 100 has numerous beneficial uses, including controlling OAM of neutrons, performing neutron holography, and the like. In an embodiment, a process for controlling OAM of the plurality of neutrons includes: subjecting OAM controller 100 to the plurality of neutrons; receiving, by OAM controller 100, the neutrons at first surface 104 of OAM controller 100; transmitting the neutrons through OAM controller 100 from first surface 104 to second surface 106 of OAM controller 100, second surface 106 being disposed opposingly across substrate 106 of OAM controller 100 from first surface 104 and including the contoured shape; and providing, by OAM controller 100, phase shift θ to a wavefunction of neutrons transmitted through OAM controller 100 to control the OAM of the neutrons according to

$$θ ∝ {T}_{1} + S \frac{φ}{2 π} .$$

Here, first thickness T₁, step height S, and azimuthal angle φ are as described above, and substrate 102 is opaque to light, opaque to electrons, opaque to X-rays, and transmits neutrons.

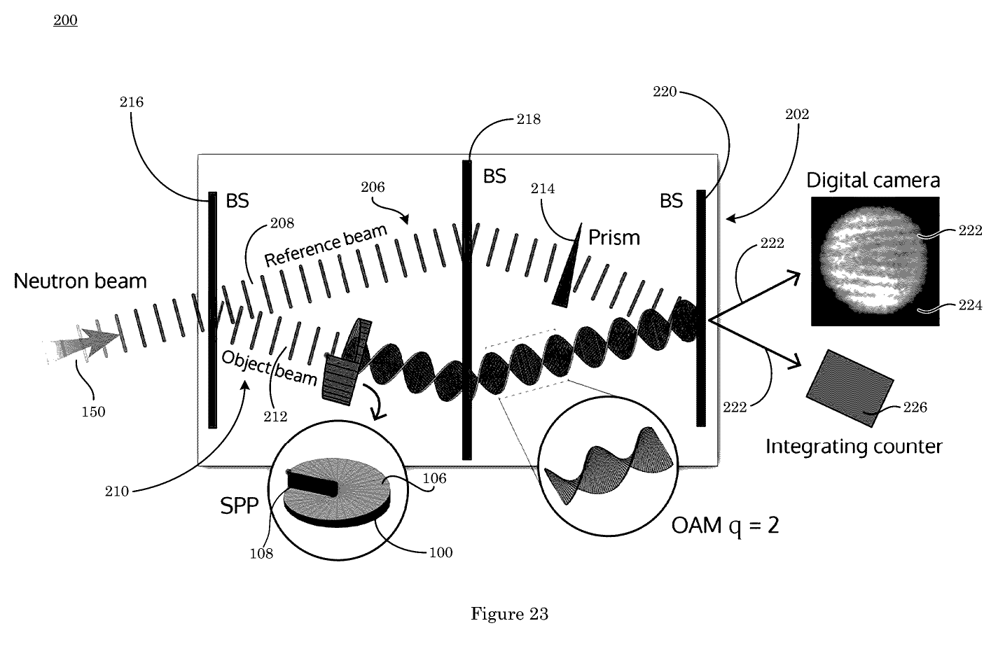

In an embodiment, with reference to FIG. 23, neutron holograph 200 includes: interferometer 202 to receive neutrons 150 and including: reference arm 206 to propagate reference beam 208; and object arm 210 to propagate object beam 212; OAM controller 100 to control OAM of neutrons in object beam 212, OAM controller 100 disposed in object arm 210 and including: substrate 102 that is opaque to light, opaque to electrons, opaque to X-rays, and transmits neutrons; first surface 104 of substrate 102; and second surface 106 of substrate 102 disposed opposingly across substrate 102 from first surface 104 and including a contoured shape that, in combination with first surface 102, controls OAM of neutrons 212; and prism 214 disposed in reference arm 206. OAM controller 100 can be a spiral phase plate.

Interferometer 202 can be a Mach-Zehnder interferometer to perform neutron holography in to a presence of OAM controller 100 that includes the spiral phase plate in object arm 210. A plurality of beamsplitters (e.g., 216, 218, 220) can be disposed in interferometer 202 to split neutron beams in a plurality of paths. Here, first beamsplitter hundred 16 can receive neutrons 150 and split them into reference beam 206 and object beam 210. Second beamsplitter 218 reflects neutrons in object arm 210 and reference arm 206, and third beamsplitter 220 coherently adds neutrons in object arm 210 and reference arm 206 to produce neutron hologram 222.

Neutrons are massive, penetrating, and neutral particles whose OAM is controlled by OAM controller 100. Accordingly, neutrons transmitted through OAM controller 100 can be used in materials characterization, quantum information, and studies quantum mechanics. Advantageously, OAM control of neutrons by OAM controller 100 provides a twist to input neutron beam 150. The twisted neutron beams 154 can be used when propagated from second surface 106 of OAM controller 100 or analyzed, e.g., by neutron interferometry. Unexpectedly and beneficially, OAM controller 100 controls OAM of spatially incoherent beams of neutrons and can be used for addition of quantum angular momenta of the neutrons along a direction of propagation of the neutrons, which can occur by transmitting the neutrons through a plurality of OAM controllers 100 arranged tandemly. Moreover, OAM controller 100 provides conservation of topological charge with respect to uniform phase fluctuations, and neutrons having OAM controlled by OAM controller 100 can be used in OAM controlled neutron-based studies of quantum information science, foundations of quantum mechanics, scattering or imaging of magnetic, superconducting or chiral material. The OAM control of neutrons herein provide well-defined values of OAM for such applications.

Beneficially, OAM controller 100 can be used in orbital angular multiplexing and demultiplexing of neutron waves to enhance signals in neutron imaging and neutron scattering applications. The processes for controlling OAM of neutrons provide a standardized reference for neutron holography.

The articles and processes herein are illustrated further by the following Examples, which are non-limiting.

### EXAMPLES

### Example 1

### OAM Control and Determination of OAM for Neutrons Transmitted Through OAM Controller

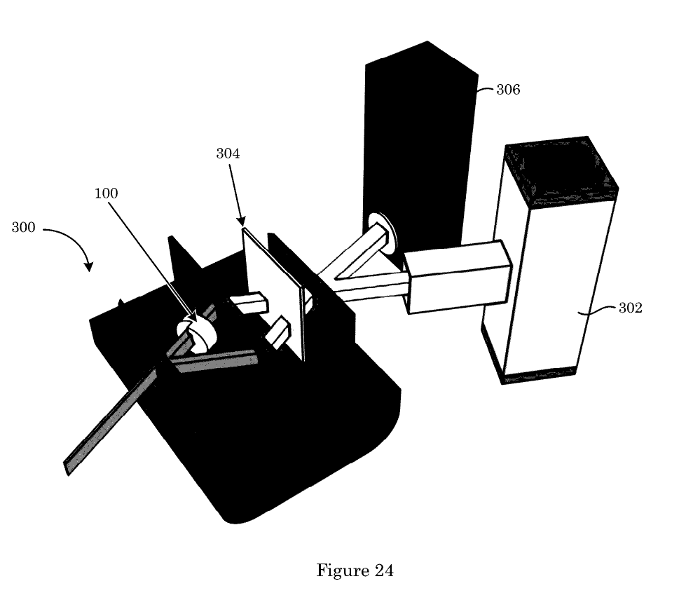

Our experiments were performed at the National Institute of Standards and Technology (NIST) Center for Neutron Research in Gaithersburg, Md., USA. Neutrons were produced by a 20-MW split-core reactor moderated with heavy water and were cooled to around 20 Kelvin by a liquid hydrogen cold source. The NIST Neutron Interferometer and Optics Facility (NIOF) facility was about 25 meters from the reactor core, and neutrons were guided to it by a multilayer neutron guide. At NIOF, neutrons were extracted from the guide by a pyrolytic graphite monochromator and collimated by a set of cadmium slits. The neutron wavelength λ=0.271 nm (energy E≈11 meV) used in the experiment was chosen to satisfy the Bragg condition (θ_{B}=25.6°) for (111) crystallographic planes of a crystal silicon interferometer. FIG. 24 shows neutron interferometer 300 used in this experiment, which had a Mach-Zehnder configuration. More particularly, the input neutron beam was coherently split into two coherent paths by Bragg diffraction at blade 1. Blade 2 was as a neutron mirror, and blade 3 recombined the neutron paths and directed them to the two neutron detectors: 302 integrating counter and two-dimensional imaging detector 306. The neutron counts recorded by the two detectors (302, 306) contained information about the relative phase of the neutron wavefunction accumulated along the two separate paths. Phase flag 304 was a 2-mm-thick fused silica plate. By positioning and rotating phase flag 304, we adjusted a uniform phase difference between the neutron paths inside interferometer 300. OAM controller was placed in one path to produce a spatial phase distribution across the neutron wavefront.

Integrating ³He detector 302 was used to align the neutron interferometer 300, monitor reactor flux, and determine experimental parameters such as the initial interferometer phase (φ₀) and interferometer contrast (C). Interferometer phase φ₀ and contrast C were measured by rotating phase flag 304 (see angle of rotation in FIG. 24) inside neutron interferometer 300 in absence of a sample. During experiments with samples integrating detector 302 monitored reactor neutron intensity.

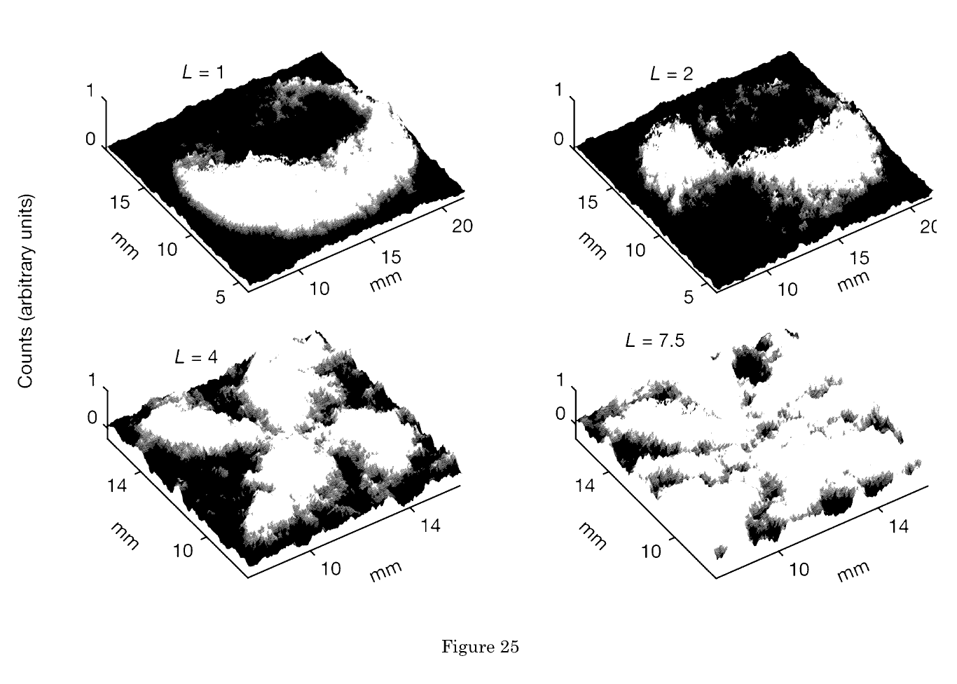

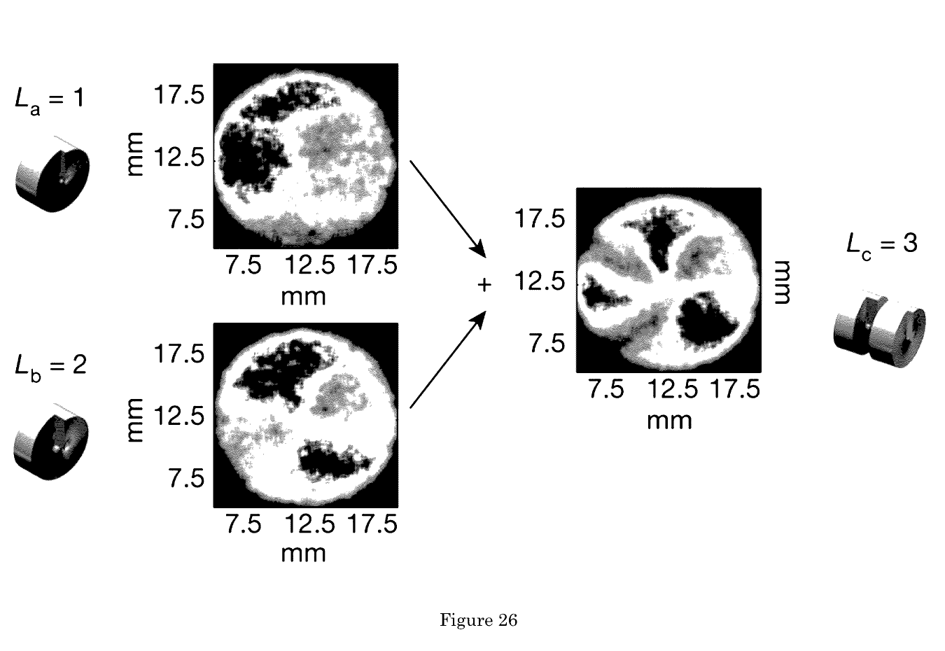

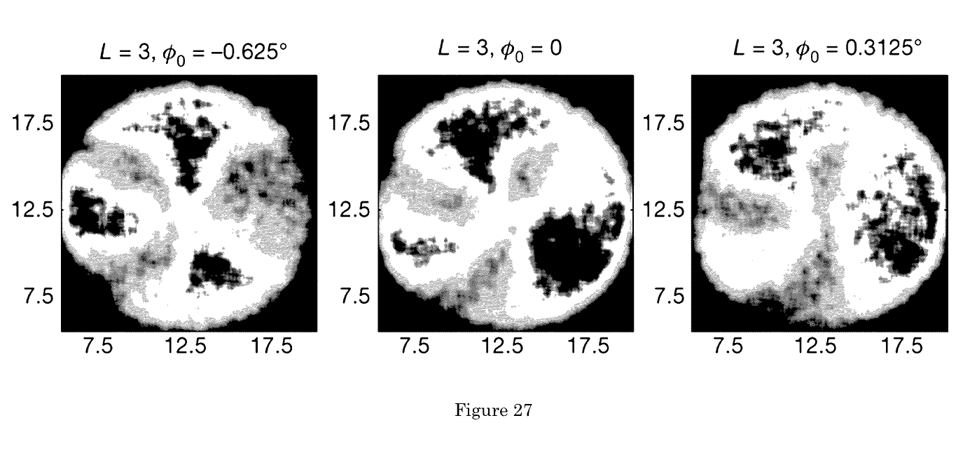

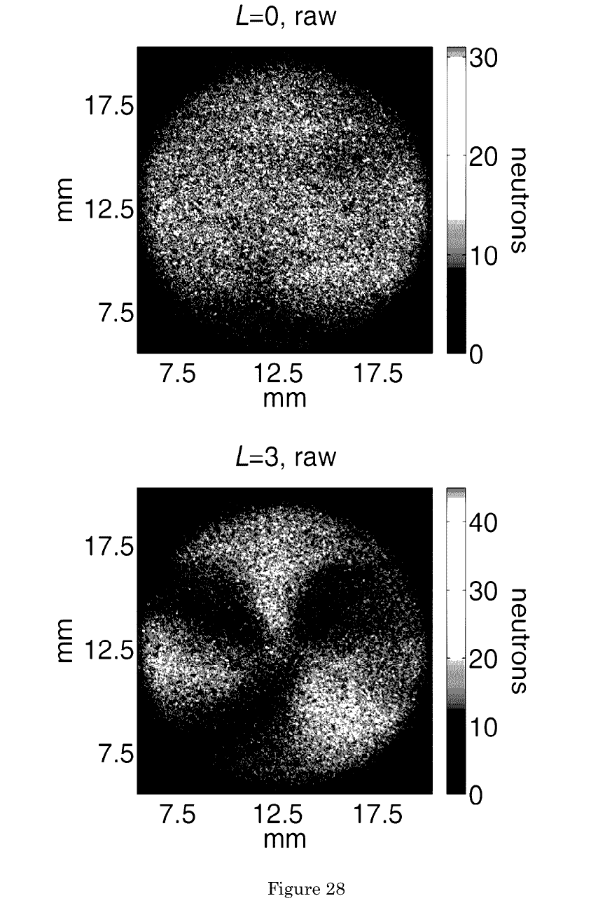

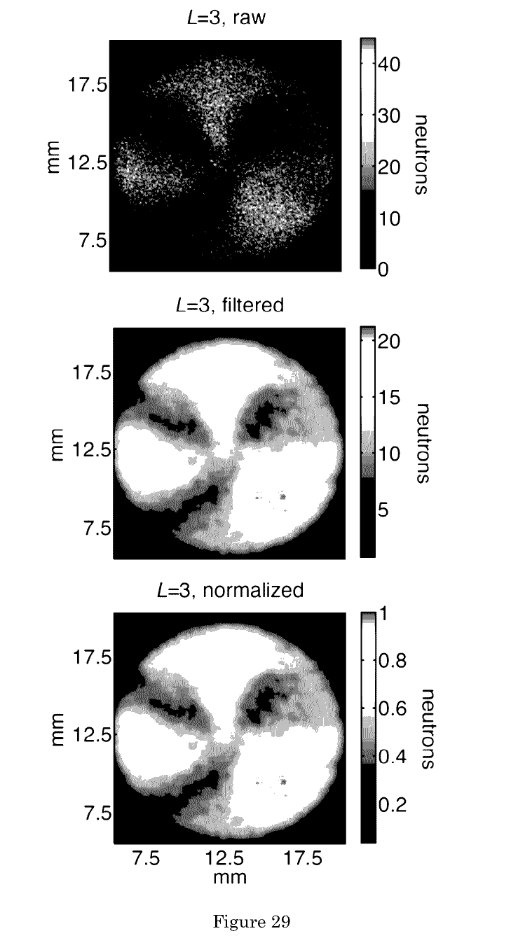

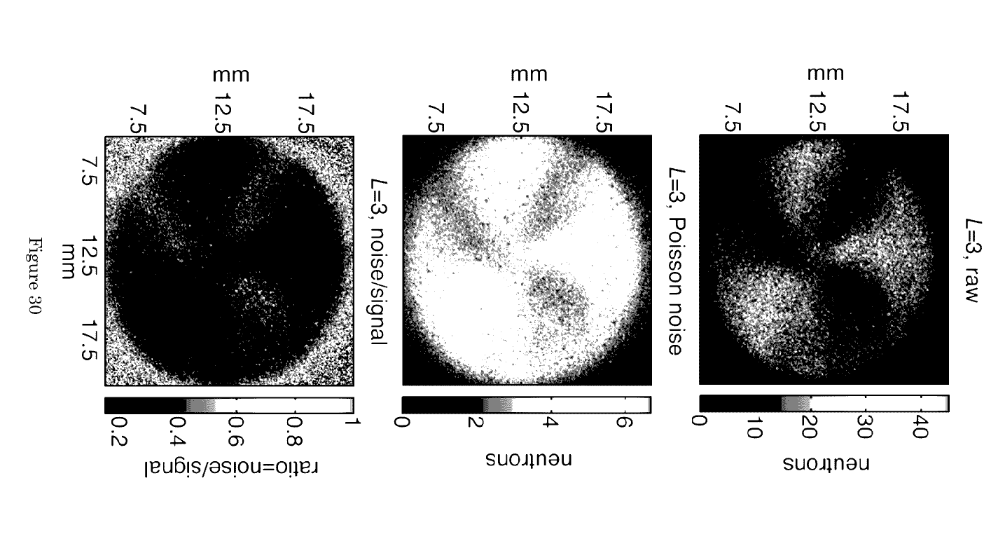

Two-dimensional (2D) imaging neutron detector 306 had a spatial resolution of 100 μm and detection efficiency of 18% at neutron wavelength λ=0.271 nm. A count rate over a whole area of 2D detector 306 was approximately 1.9 neutrons per second, and a measurement time for each image collection was 3.5 days. The interferometer phase drift was 1° per day, and the image noise per pixel was statistically limited. Images shown in FIG. 25, FIG. 26, and FIG. 27 were obtained with 2D detector 306, filtered with an averaging filter over 10×10 pixels, and normalized to a maximum count. Raw images of 2D detector 306 without filtering and normalization are shown in FIG. 28, FIG. 29, and FIG. 30. Integrating counter 302 was a ³He detector with nearly 100% efficiency.

Two OAM controllers 100 shown in FIG. 21 and FIG. 22 were machined out of dowels of Al 6061 alloy by a 5-axis computer numerical control milling machine at NIST's machine shop, following two different procedures. The smaller OAM controller (10 mm diameter, shown in FIG. 21) was cut by rotating the Al dowel and moving the end mill out. The larger OAM controller (15 mm in diameter, shown in FIG. 22) was milled in the form of a helical staircase with approximately 200 treads.

The system (i.e., neutron interferometer 300 with OAM controller 100, phase flag 304, and neutron detectors 302 and 306) was located within three nested enclosures (Matryoshka-style). To minimize phase drifts during week-long data collection, the temperature of the innermost enclosure was actively controlled to remain at 24° C. within 5 milliKelvin (mK). The middle enclosure was a Faraday cage with temperature isolation and sound damping. The setup sat on a 40,000-kilogram (kg) vibration-isolated table suspended on air springs from a platform decoupled from the floor of the NIST reactor facility. Vibration isolation actively suppressed mechanical noise spectrum greater than 0.5 Hz and was controlled with micrometer precision. Changing the OAM controllers involved opening the three nested enclosures, and we waited about 24 hours afterwards for the system to return to equilibrium.

The input neutron beam to neutron interferometer 300 contained a mixture of OAM states and was spatially incoherent over the transverse displacement of the neutron paths. The neutron OAM states that were generated were analyzed using interferometry. We fabricated several OAM controllers 100 that corresponded to phase circulation of 2π, 4π, 8π, and 15π around the singularity of the wavefunction, or average orbital momenta of L=1, 2, 4, and 7.5. With reference to FIG. 24, the input neutron wavefunction was split along two paths in neutron interferometer 300. Both neutron paths passed through phase flag 304 (2-mm-thick plate) with which we controlled a relative overall phase difference between paths. One neutron path passed through OAM controller 100, which imprinted an azimuthal phase upon the neutron wavefront. Up to a common overall phase, the neutron wavefunction at the entrance of 2D detector 306 was described in cylindrical coordinates centered at the axis of OAM controller as provided in formula 6

Ψ=(c₁e^{iLφ}+c₂e^{-iφ}^{₀}⁾Ψ₀ (6),

wherein φ was the azimuthal angle about the beam propagation axis; c₁ and c₂ were amplitudes composed of neutron reflection and transmission coefficients of the interferometer blades, φ₀ was the phase due to phase flag 304, and Ψ₀ was the wavefunction of a neutron entering neutron interferometer 300. The spatially resolved neutron fluence rate at 2D detector 306 was provided by a proportionality of formula 7

I_{2D}(ρ,φ,θ)∝[1+C cos(Lφ+φ₀)]|Ψ₀|² (7),

wherein 0≦C≦1 is the interferometric contrast of neutron interferometer 300. For neutron interferometer 300, C=0.84 without background correction.

One or two OAM controllers 100 was disposed into one of the paths of neutron interferometer 300 so the neutron in that path acquired a variation of phase across its wavefront. The second blade of neutron interferometer 300 was lossy mirror in which part of the incident neutron beam was transmitted through the blade and left neutron interferometer 300 (not shown). The remainder of the neutron beam was Bragg-scattered towards the third blade of neutron interferometer 300. The two paths from the second blade reconnected coherently at the third blade. The third blade combined the interfering transmitted/Bragg-diffracted neutron paths and directed them into 2D detector 306 and integrating ³He neutron counter 302. Phase flag 304 was a 2-mm-thick plate of fused silica that was interposed between the second and third blades of neutron interferometer 300. Phase flag 304 was rotated to introduce and control a spatially uniform phase difference between neutron paths in neutron interferometer 300. The spatially resolved data from 2D detector 306 provided information on the spatial phase imported on the neutron wavefront by OAM controller 100 in neutron interferometer 300.

FIG. 25 shows 2D images using 2D position-sensitive detector 306 disposed after the third blade of neutron interferometer 300. The interferograms shown in FIG. 25 were a false-color spatial representation of time-integrated neutron intensity per pixel of 2D detector 306. In particular, FIG. 25 shows spatial distribution of neutron counts in 2D detector 306 of the neutron interferometer 300 for four OAM controllers 100 with values of L=1, 2, 4, and 7.5 as labelled in FIG. 25. Horizontal and vertical positions on 2D neutron detector 306 are shown in millimeters. For integer values of L, the distributions had OAM interference pattern provided by formula (7); for L=7.5 we have the superposition of OAM modes given by formula (2). 2D detector 306 was a centroid-type event-counting detector with a spatial resolution of 100 μm and an 18% quantum efficiency (i.e., counts registered per neutron incident on the detector). Its operation was shot-noise (Poisson-noise) limited in this regime. The neutron counts were collected over 3.5 days and normalized by the maximal pixel count, which is about 45.

Raw data, data manipulation, and data noise are shown in FIG. 28, FIG. 29, and FIG. 30. Particularly, FIG. 28 shows raw neutron count data obtained over about 80 contiguous hours of data collection with 2D imaging detector 306. False-color representation of neutron counts per pixel were indicated by scale on the image. On the left of FIG. 28 is an image of OAM controller 100 with L=0 that was equivalent to a uniform phase plate. On the right of FIG. 28 is an image of an L=3 compound OAM controller in which two OAM controllers 100 were tandemly disposed in neutron interferometer 300 as discussed in reference to FIG. 27. Horizontal and vertical positions on 2D neutron detector 306 are shown in millimeters.

FIG. 29 shows output from conversion of raw images collected on 2D detector 306 to the images shown in FIG. 25, FIG. 26, and FIG. 27 in which panel a of FIG. 29 shows raw data. Panel b shows the same data but passed through 2D averaging filter with averaging taken over a 10 pixel×10 pixel square. Panel c shows filtered data normalized to maximum value of intensity in panel b. Horizontal and vertical positions on 2D neutron detector 306 are shown in millimeters.

FIG. 30 shows output from modelling effects of shot noise in the raw images collected on 2D detector 306 and images shown in FIG. 25, FIG. 26, and FIG. 27 in which panel a of FIG. 30 shows raw data. Panel b shows Poisson noise or a square root of each pixel shown in panel a. Panel c shows noise-to-signal ratio of the image in panel a. Horizontal and vertical positions on 2D neutron detector 306 are shown in millimeters.

Results generated by OAM controllers 100 with S=112 μm, 224 μm, 448 μm, and 840 μm, which corresponded to L=1, 2, 4, and 7.5, are shown in FIG. 25. If effective thickness L was close to an integer value, the interferogram was dominated by a pattern corresponding to OAM l≈L. For integer values of L, sharp angular distributions of neutron intensity were observed that were dominated by the contribution from l≈L. For non-integer L, a distributed superposition of contributions from numerous values of l were observed.

Using a plurality of OAM controllers 100 arranged in tandem provided for addition of angular momenta. With reference to FIG. 26, two OAM controllers 100 were used in tandem with step heights corresponding to different OAMs Lₐ and L_{b}. A net control of OAM by tandem OAM controllers 100 to the neutron beam was L_{c}=Lₐ+L_{b}. Accordingly, tandem OAM controllers 100 empirically demonstrated the elementary proposition 1+2=3 via control of OAM in the neutron beam. Moreover, composite angular momentum L_{c} transformed as a true angular momentum under rotations of the tandem OAM controllers 100 about their symmetry axes, as well as with respect to interference with the beam in the other arm of neutron interferometer 300 as shown in FIG. 27.

More particularly, FIG. 26 shows results for addition of OAM along the direction of propagation accomplished by using tandem OAM controllers 100. Here, on the left of FIG. 26 are two interferograms obtained separately with different OAM controllers 100, wherein a first OAM controller 100 had an effective OAM Lₐ=1 and step height S=112 μm, and a second OAM controller 100 had an effective OAM L_{b}=2 and step height S=224 μm. Horizontal and vertical positions on 2D neutron detector 306 are shown in millimeters. On the right of FIG. 26 is the interferogram obtained by concatenating both OAM controllers 100 in path I of neutron interferometer 300 (in the configuration indicated in FIG. 26) to make a tandem OAM controller 100 (i.e., two OAM controllers arranged in serial communication with respect to the neutron beam) with L_{c}=Lₐ+L_{b}=3.

FIG. 27 provides results that show rotational invariance. Here, interferograms shown in FIG. 27 were obtained using tandem OAM controllers 100 with total L=3, as described with regard to FIG. 26 for different positions of phase flag 304 (see FIG. 24). Horizontal and vertical positions on 2D neutron detector 306 are shown in millimeters. The three images were acquired at different settings of phase flag 304 that corresponded to the values φ₀=−0.625°, 0°, and 0.3215°. The image rotated by the angle that was proportional to rotation of phase flag 304. The average OAM was independent of the position of phase flag 304, i.e., L was preserved.

The experimental results demonstrated control of OAM of neutrons using OAM controller 100. The average OAM of the neutron beams were measured using neutron interferometer 300. The interferometric experiments exemplified the particle-wave duality of neutrons. Neutrons were detected as individual particles, and the neutrons traversed space like waves that carried quantized values of OAM. The interferograms that were acquired showed that of these individual states of the neutrons had its OAM changed by the same amount when transmitted through OAM controller 100 of integer order. Two OAM controllers 100 disposed tandemly, i.e., in series increased the OAM of the neutrons by the sum of the OAM produced by each OAM controller 100 when disposed alone in the path of propagation of the neutron beam and demonstrated additivity of OAM and conservation of vortex topological charge.

### Example 2

### Neutron Holography

In this example, with reference to FIG. 23, results are reported from neutron holography with neutron holograph 200 that included Mach-Zehnder interferometer 202 in which was disposed OAM controller 100 that was configured as a spiral phase plate. Here, object beam 212 was transmitted through OAM controller 100. OAM controller 100 controlled the OAM of the neutron beam in object beam 212 that propagated in object arm 210 such that neutrons in object beam 212 acquired a phase twist characteristic of their orbital angular momentum states. Reference beam 208 passed through fused silica prism 214 and acquired a linear phase gradient. The resulting neutron hologram 222 was a fork dislocation image, which can be used to reconstruct neutron beams with various OAM.

As shown in FIG. 23, object beam 212 included neutrons that were transmitted through aluminum OAM controller 100 (that was configured as a spiral phase plate (SPP)) in object arm 210 of the neutron interferometer 202 of neutron holograph 200. OAM controller 100 imparted an azimuthal phase of ow upon input neutron beam 150, where q was the topological charge of OAM controller 100. Without prism 214 in reference arm 206, the interferogram at camera 222 displayed the topological charge of object beam 210, which was the same as that of a beam with OAM of l, wherein l=q. Prism 214 was disposed in reference arm 206 and interacted with reference beam 208 to produce a linear gradient and tilt the phase front of reference beam 208. An intensity at camera 224 was provided by I∝ Cos(k_{y}ŷ−q\hat{φ}).

Particularly, FIG. 23 shows neutron holography of neutron beam 150 that entered Mach-Zehnder interferometer 202 and was separated into reference beam 206 and object beam 212 by first beamsplitter 216. OAM controller 100 with q=2 was disposed in object arm 210 and produced object beam 212. Prism 214 tilted the phase front of neutrons in reference arm 206 to provide reference beam 208. Object beam 212 and reference beam 208 were reflected at beamsplitter 218 and were added coherently at beamsplitter 220. One of output beams 222 of beamsplitter 220 was sent to imaging detector 224, and another to integrating counter 226 monitored intensities.

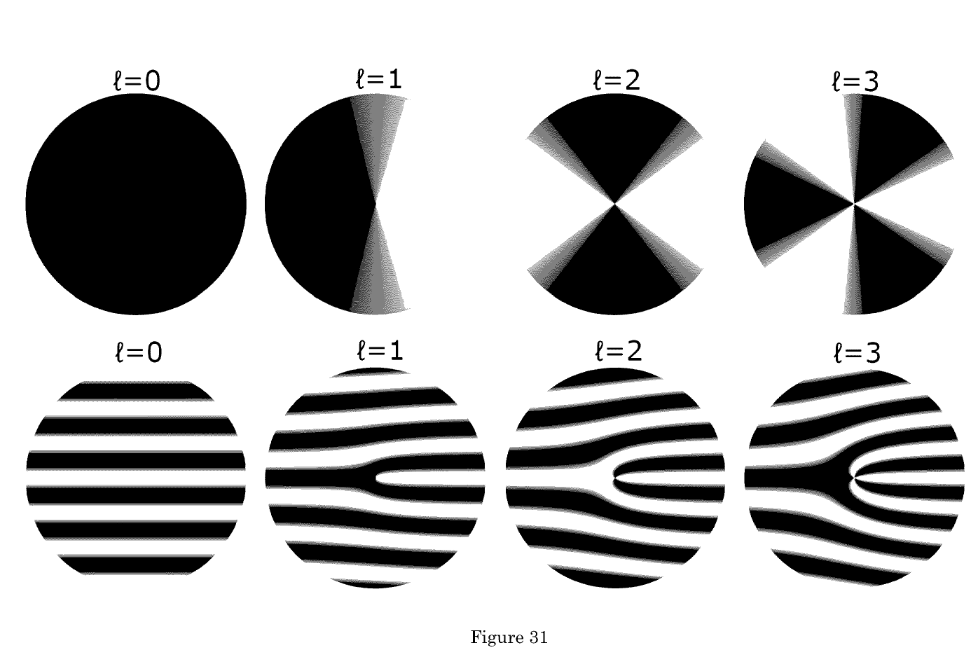

Interferogram acquired by camera 224 resembled forked grating images. Simulated interferograms with and without prism 214 disposed in reference arm 206 are shown in FIG. 31. Particularly, panel a of FIG. 31 shows simulation results of intensity profiles at 2D detector 224 for OAM controllers 100 with topological charges of l=0; 1; 2; and 3 in object beam 212 in an absence of prism 214 in reference arm 206. Panel b of FIG. 31 shows simulation results of intensity profiles at 2D detector 224 for OAM controllers 100 with topological charges of l=0; 1; 2; and 3 in object beam 212 in a presence of prism 214 in reference arm 206. The holographic process was completed by applying a digital reconstruction of the obtained forked structure (to profiles in panel b), wherein resulting images yielded phase and intensity profiles associated with OAM controller 100.

Holography of the neutrons using neutron holograph 200 that included OAM controller 100 provided a direct connection between refractive and diffractive mechanisms of OAM imprinting of particles and waves. This example was the first demonstration of neutron holography.

Neutron holography was performed at the Neutron Interferometry and Optics Facility (NIOF) at the National Institute of Standards and Technology (NIST) Center for Neutron Research (NCNR). Neutrons generated by a 20 MW nuclear research reactor were cooled via a liquid hydrogen moderator, and passed through a guidehall. A monochromator at NIOF beamline selected energies of 11 meV, equivalent to a deBroglie wavelength of 0.271 nm. This cold neutron beam was incident on neutron interferometer 202. Neutron interferometer 202 was made using a single ingot of silicon machined so that it had three blades (beamsplitters 216, 218, 220) supported by a common base. The common base insured arcsecond alignment between crystalline beamsplitters 216, 218, 220. Neutrons that entered neutron interferometer 202 were Bragg diffracted by the (111) lattice planes of beamsplitter 216 and formed two spatially separate paths, namely reference beam 208 and object beam 212. Phase differences between these reference beam 208 and object beam 212 produced interference at beamsplitter 220. The interference was detected using either fully integrating ³He filled proportional counter 226 or neutron sensitive imaging camera 224.

OAM controller 100 was made of aluminum with q=2 and was disposed in object beam 210. In reference arm 206, a vertical linear gradient was introduced by using two identical fused silica wedges arranged back-to-back to form prism 214. The wedges had a 6° angle, and each could be rotated independently a full rotation of 2π. Any non-gradient phase shift inside the interferometer 202 only shifted the pattern at camera imaging detector 224.

Integrating counter 226 measured an average rate of neutrons exiting interferometer 202, which was about r=20 s⁻¹. Based on this rate, an average time interval τ=1/r=50 ms occurred between detection of successive neutrons at integrating counter 226. Because the distance from the reactor was 30 m with neutron velocity v=1;460 m/s, neutrons took 20 ms to travel to interferometer 202 so that when a neutron was detected, a subsequent neutron had not been made in the reactor.

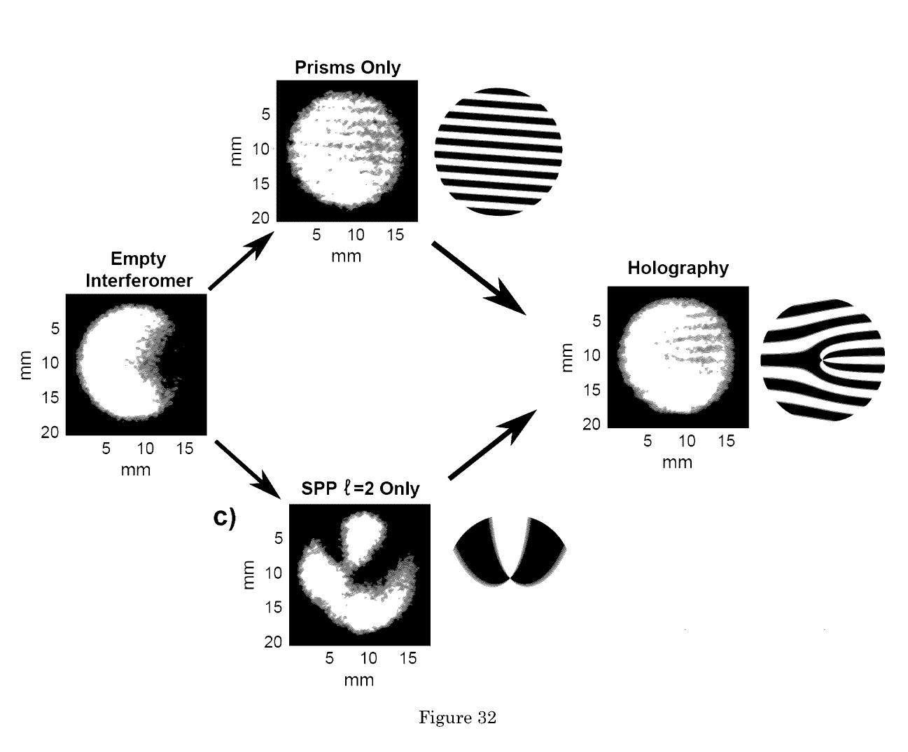

For the images depicted in FIG. 32, the wedges respectively were rotated to 10° and −10°. This arrangement gave a theoretical phase gradient of 5200 rad/m. Reactor fluctuation was monitored using ³He detector 226. Images were recorded on neutron sensitive camera 224 that had a 25 mm diameter active area and 100 mm resolution. Neutron detection efficiency was 18%, and individual images were taken in 4 hour runs.

FIG. 1 shows location of camera 224 in neutron holograph 200. Simulated intensities at camera 224 for q=0; 1; 2; 3 OAM controllers 100 in object beam 212 are shown in panel a of FIG. 31, and panel b shows intensities when prisms 214 were added to reference arm 210 to provide the linear gradient.

Panels of FIG. 32 shows experimental results for various arrangements along with the corresponding simulations. In particular, panel a of FIG. 32 shows the grayscale intensity profile obtained with interferometer 202 empty, i.e., without prism 214 present in reference arm 206. The input beam was non uniform and provided a horizontal gradient across interferometer 202 due to beamsplitters 216, 218, 220.

Panel b of FIG. 32 shows theoretical and experimental images corresponding to when prisms 214 were placed in reference arm 206 of interferometer 202 to receive reference beam 208 and to produce a vertical gradient. A number of fringes in the simulation for the theoretical phase was 5200 rad/m.

Panel c of FIG. 32 shows the image at imaging detector 224 when OAM controller 100 (had q=2) was disposed in object beam 212. Due to the mentioned gradient, the image had a deviation from a helical phase profile of l=q=2.

Panel d of FIG. 32 shows the image at imaging detector 224 when prisms 214 were disposed reference arm 206 to receive reference beam 208 and OAM controller 100 (had q=2) was disposed in object arm 210. The fork grating pattern was present in the image acquired by imaging detector 224.

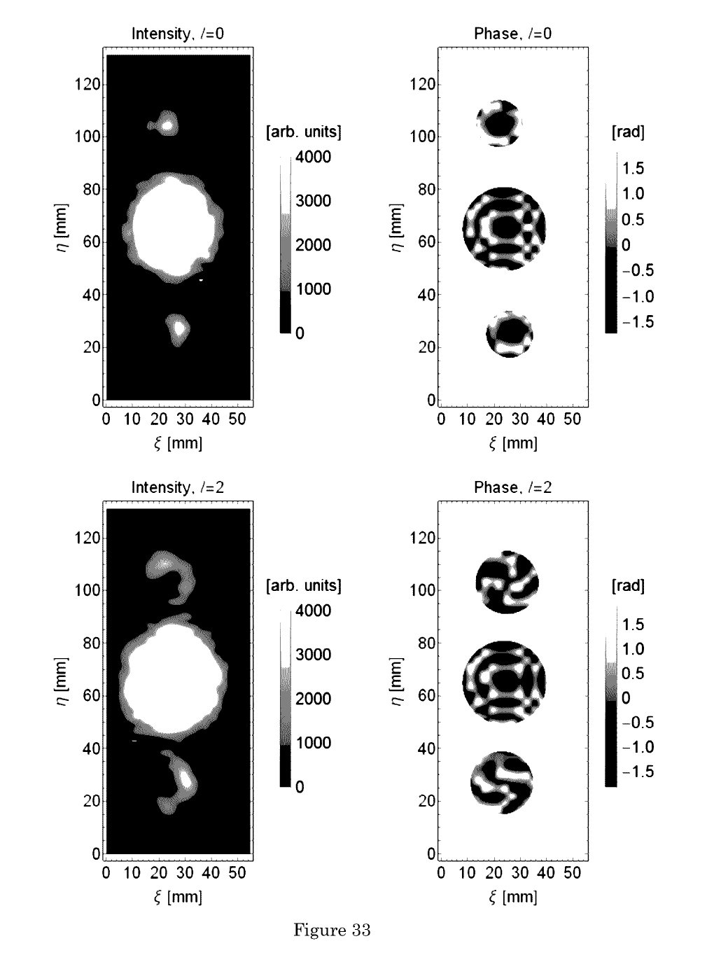

FIG. 33 shows numerical reconstruction of the experimental images shown in panel b and panel of FIG. 32. The reconstruction was obtained by solving the Fresnel-Kirchhoff diffraction integral in the Fresnel limit for λd=70 mm². From the uniform intensity distribution, the zero diffraction order corresponded to l=0, and the first diffraction order showed a doughnut profile due to the neutron beam carrying OAM after being transmitted through OAM controller 100. The plot of the reconstructed phase confirmed that the first diffraction beams corresponded to beams with l=2. In FIG. 33, the phase was that of the spherical phase front. The images were interpolated from a 20×48 array. The mask for the phase plots was included for clarity.

While one or more embodiments have been shown and described, modifications and substitutions may be made thereto without departing from the spirit and scope of the invention. Accordingly, it is to be understood that the present invention has been described by way of illustrations and not limitation. Embodiments herein can be used independently or can be combined.

Reference throughout this specification to “one embodiment,” “particular embodiment,” “certain embodiment,” “an embodiment,” or the like means that a particular feature, structure, or characteristic described in connection with the embodiment is included in at least one embodiment. Thus, appearances of these phrases (e.g., “in one embodiment” or “in an embodiment”) throughout this specification are not necessarily all referring to the same embodiment, but may. Furthermore, particular features, structures, or characteristics may be combined in any suitable manner, as would be apparent to one of ordinary skill in the art from this disclosure, in one or more embodiments.

All ranges disclosed herein are inclusive of the endpoints, and the endpoints are independently combinable with each other. The ranges are continuous and thus contain every value and subset thereof in the range. Unless otherwise stated or contextually inapplicable, all percentages, when expressing a quantity, are weight percentages. The suffix “(s)” as used herein is intended to include both the singular and the plural of the term that it modifies, thereby including at least one of that term (e.g., the colorant(s) includes at least one colorants). “Optional” or “optionally” means that the subsequently described event or circumstance can or cannot occur, and that the description includes instances where the event occurs and instances where it does not. As used herein, “combination” is inclusive of blends, mixtures, alloys, reaction products, and the like.

As used herein, “a combination thereof” refers to a combination comprising at least one of the named constituents, components, compounds, or elements, optionally together with one or more of the same class of constituents, components, compounds, or elements.

All references are incorporated herein by reference.

The use of the terms “a” and “an” and “the” and similar referents in the context of describing the invention (especially in the context of the following claims) are to be construed to cover both the singular and the plural, unless otherwise indicated herein or clearly contradicted by context. “Or” means “and/or.” Further, the conjunction “or” is used to link objects of a list or alternatives and is not disjunctive; rather the elements can be used separately or can be combined together under appropriate circumstances. It should further be noted that the terms “first,” “second,” “primary,” “secondary,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

What is claimed is:

1. An orbital angular momentum (OAM) controller to control OAM of a plurality of neutrons, the OAM controller comprising:
a substrate;
a first surface of the substrate; and
a second surface of the substrate disposed opposingly across the substrate from the first surface and comprising a contoured shape that, in combination with the first surface, controls the OAM of the neutrons.

2. The OAM controller of claim 1, wherein a thickness of the substrate varies as a function of an azimuthal angle φ of the substrate.

3. The OAM controller of claim 2, wherein the thickness of the substrate varies uniformly as a function of the azimuthal angle φ of the substrate.

4. The OAM controller of claim 2, wherein the thickness of the substrate is constant as a function of a radial position of the substrate.

5. The OAM controller of claim 1, wherein the OAM controller further comprises a spiral phase plate.

6. The OAM controller of claim 1, wherein the substrate is opaque to light, opaque to electrons, and transmits neutrons.

7. The OAM controller of claim 6, wherein the substrate also is opaque to X-rays.

8. The OAM controller of claim 6, wherein the substrate comprises a transition metal.

9. The OAM controller of claim 6, wherein the transition metal comprises aluminum.

10. The OAM controller of claim 6, wherein the substrate is not activated in response to transmitting the neutrons through the substrate.

11. The OAM controller of claim 4, wherein the OAM controller imparts a phase shift to a wavefunction of the neutrons that are transmitted through the OAM controller.

12. The OAM controller of claim 11, wherein the phase shift is proportional to a local thickness of the substrate.

13. The OAM controller of claim 12, wherein, for neutrons that are transmitted through the controller, the wavefunction acquires an azimuthal phase distribution provided by e^{iLφ},
wherein L is an integer, and i is equal to a square root of −1.

14. The OAM controller of claim 13, wherein an azimuthal distribution of the thickness of the substrate is selected for a specific value of L such that neutrons that are transmitted through the collector comprise a value of OAM that is equal to L.

15. The OAM controller of claim 13, wherein the wavefunction of the neutrons prior to transmission through the OAM controller comprises a planar wavefunction.

16. An orbital angular momentum (OAM) controller to control OAM of a plurality of neutrons, the OAM controller comprising:
a substrate;
a first surface of the substrate; and
a second surface of the substrate disposed opposingly across the substrate from the first surface and comprising a contoured shape that, in combination with the second surface, controls the OAM of the neutrons,
the OAM controller:
being a spiral phase plate that comprises a variation in a thickness of the substrate as a function of an azimuthal angle φ of the substrate, and
providing a phase shift θ to a wavefunction of neutrons transmitted through the OAM controller according to
$$θ ∝ {T}_{1} + S \frac{φ}{2 π} ,$$
wherein T1 is a first thickness of the substrate, S is a step height of the substrate, and φ is the azimuthal angle of the substrate, and
wherein the substrate is opaque to light, opaque to electrons, opaque to X-rays, and transmits neutrons.

17. A neutron holograph comprising:
an interferometer comprising:
a reference arm to propagate a reference beam; and
an object arm to propagate an object beam;
an orbital angular momentum (OAM) controller to control OAM of a plurality of neutrons, the OAM controller disposed in the object arm and comprising:
a substrate that is opaque to light, opaque to electrons, opaque to X-rays, and transmits neutrons;
a first surface of the substrate; and
a second surface of the substrate disposed opposingly across the substrate from the first surface and comprising a contoured shape that, in combination with the second surface, controls the OAM of the neutrons; and
a prism disposed in the reference arm.

18. The neutron holograph of claim 17, wherein the OAM controller further comprises a spiral phase plate.

19. A process for controlling orbital angular momentum (OAM) of a plurality of neutrons, the process comprising:
subjecting an OAM controller to a plurality of neutrons;
receiving, by the OAM controller, the neutrons at a first surface of the OAM controller;
transmitting the neutrons through the OAM controller from the first surface to a second surface of the OAM controller, the second surface being disposed opposingly across a substrate of the OAM controller from the first surface and comprising a contoured shape; and
providing, by the OAM controller, a phase shift θ to a wavefunction of neutrons transmitted through the OAM controller to control the OAM of the neutrons according to
$$θ ∝ {T}_{1} + S \frac{φ}{2 π} ,$$
wherein T₁ is a first thickness of the substrate, S is a step height of the substrate, and φ is the azimuthal angle of the substrate, and
the substrate is opaque to light, opaque to electrons, opaque to X-rays, and transmits neutrons.
